(19) United States
(12) Patent Application Publication
(10) Pub. No.: US 2018/0173479 A1
(43) Pub. Date: Jun. 21, 2018

(54) IMAGE FORMING APPARATUS CAPABLE OF MOUNTING APPLICATION AND METHOD FOR CONTROLLING THE SAME

(71) Applicant: CANON KABUSHIKI KAISHA, Tokyo (JP)

(72) Inventor: Seiya Kurabe, Toride-shi (JP)

(21) Appl. No.: 15/844,224

(22) Filed: Dec. 15, 2017

(30) Foreign Application Priority Data
Dec. 20, 2016 (JP) 2016-247183

(51) Int. Cl. G06F 3/12; H04L 29/08

(52) U.S. Cl. CPC G06F 3/1285; G06F 3/1225; G06F 3/1297; G06F 3/1294; H04L 67/025

(57) ABSTRACT

The present invention efficiently develops a function of displaying both information about an image forming apparatus and information about an extended application. The present invention discloses the image forming apparatus capable of mounting a storage control unit that is an example of system software and the extended application for extending the function of the image forming apparatus. The image forming apparatus acquires multifunction peripheral (MFP) information obtained by executing system software of an MFP that is an example of an image forming apparatus and information about the extended application obtained from the extended application, and outputs, based on the acquired information, information to be displayed on a web browser different from the extended application.

### BACKGROUND

### Field of the Disclosure

The present disclosure relates to an image forming apparatus capable of mounting an application that can expand the function of the image forming apparatus and a method for controlling the same.

### Description of the Related Art

There is an increase in the use of systems capable of installing an extended application in an image forming apparatus to expand the function of the image forming apparatus. These systems have an execution environment for operating an extended application in addition to a control application of an image forming apparatus (see Japanese Patent Application Laid-Open No. 2006-140898).

### SUMMARY

According to an aspect of the present disclosure, an image forming apparatus capable of mounting system software for controlling the image forming apparatus and an extended application operating on the system software includes an output unit configured to output, based on an access to a uniform resource identifier (URI) corresponding to the image forming apparatus, first display information based on information acquirable from the system software of the image forming apparatus and second display information acquirable from the extended application, different from the first display information, to display the first and the second display information in a web browser.

Further features of the present invention will become apparent from the following description of exemplary embodiments with reference to the attached drawings.

### BRIEF DESCRIPTION OF THE DRAWINGS

FIG. 1 illustrates an example of a hardware configuration of a multifunction peripheral (MFP) that is an example of an image forming apparatus according to one or more aspects of the present disclosure.

FIG. 2 illustrates an example of a software configuration of an extended application execution environment for the image forming apparatus according to one or more aspects of the present disclosure.

FIG. 3 illustrates an example of a software module configuration of the image forming apparatus according to one or more aspects of the present disclosure.

FIG. 4 illustrates an example of a network system according to one or more aspects of the present disclosure.

FIG. 5 is an example of a flowchart illustrating processing for a Hypertext Transfer Protocol (HTTP) request reception according to one or more aspects of the present disclosure.

FIG. 6 is a sequence diagram illustrating an example of a processing flow of extended application screen display according to one or more aspects of the present disclosure.

FIG. 7 illustrates an example of a flowchart illustrating an HTTP request check according to one or more aspects of the present disclosure.

FIG. 8 is a sequence diagram illustrating another example of a processing flow of extended application screen display according to one or more aspects of the present disclosure.

FIG. 9 illustrates an example of an extended application display screen according to one or more aspects of the present disclosure.

FIG. 10 illustrates another example of an extended application display screen according to one or more aspects of the present disclosure.

FIG. 11 schematically illustrates information used when displaying an extended application display screen according to one or more aspects of the present disclosure.

FIG. 12 illustrates still another example of a flowchart illustrating processing for extended application screen display according to one or more aspects of the present disclosure.

### DESCRIPTION OF THE EMBODIMENTS

An aspect of the present disclosure will be described below with reference to the accompanying drawings.

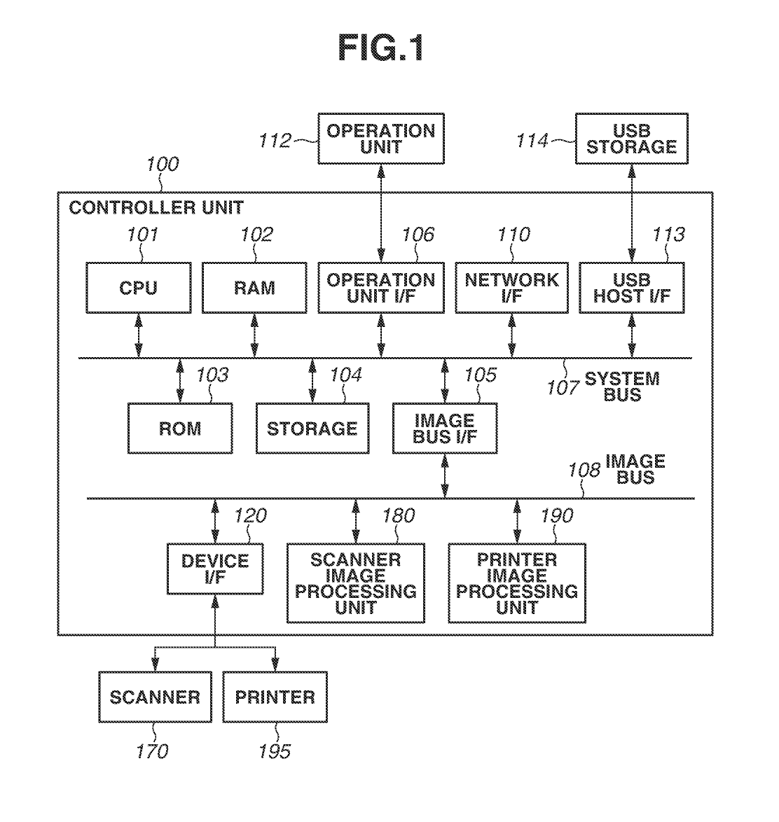

FIG. 1 is a block diagram illustrating an example of a configuration of an essential part of an image forming apparatus. The image forming apparatus includes a controller unit 100. The controller unit 100 is connected with a scanner 170 serving as an image input device and a printer 195 serving as an image output device. The controller unit 100 is also connected with an operation unit 112. The controller unit 100 controls processing of the following copy function. The copy function is implemented when the printer 195 prints image data read by the scanner 170.

The controller unit 100 includes a central processing unit (CPU) 101. The CPU 101 activates an operation system (OS) by using a boot program stored in a read only memory (ROM) 103. The CPU 101 executes on the OS an application stored in a storage 104. A random access memory (RAM) 102 is used as a work area for the CPU 101. The RAM 102 provides an work area and also an image memory area for temporarily storing image data. The storage 104 stores applications (including extended applications) and image data.

The CPU 101 is connected with the ROM 103, the RAM 102, and the operation unit interface (I/F) 106 via a system bus 107. The system bus 107 is connected with a network I/F 110 and a universal serial bus (USB) host I/F 113. The system bus 107 is also connected with an image bus I/F 105. The operation unit I/F 106 is an interface to the operation unit 112 having a touch panel. The operation unit I/F 106 outputs to the operation unit 112 an image to be displayed on the operation unit 112. The operation unit I/F 106 also transmits to the CPU 101 information input on the operation unit 112 by a user. The network I/F 110 is an interface for connecting the image forming apparatus to a local area network (LAN).

A USB host I/F 113 is an interface unit for communicating with a USB storage 114. The USB host I/F 113 is an output unit for storing in the USB storage 114 the data stored in the storage 104. The USB host I/F 113 inputs the data stored in the USB storage 114 and transmits the data to the CPU 101. The USB storage 114, an external storage device for storing data, can be detachably attached to the USB host I/F 113. The USB host I/F 113 can be connected with a plurality of USB devices including the USB storage 114.

The image bus I/F 105 connects the system bus 107 and an image bus 108 for transferring image data at high speed. The image bus I/F 105 serves as a bus bridge for converting the data format. The image bus 108 is configured by a Peripheral Component Interconnect (PCI) bus or Institute of Electrical and Electronics Engineers (IEEE) 1394. On the image bus 108, a device I/F 120, a scanner image processing unit 180, and a printer image processing unit 190 are provided. The device I/F 120 is connected with a scanner 270 and the printer 195. The device I/F 120 performs image data conversion between a synchronous system and an asynchronous system. The scanner image processing unit 180 corrects, processes, and edits input image data. The printer image processing unit 190 performs correction and resolution conversion on print output image data according to the printer 195.

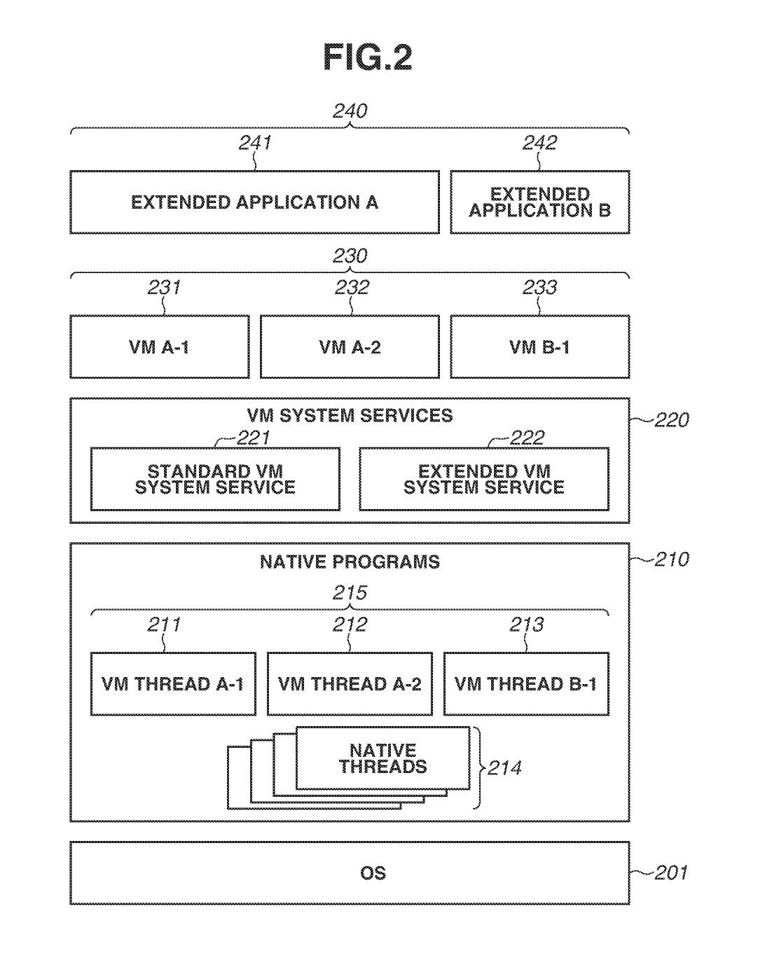

FIG. 2 is a block diagram illustrating an example of an extended application execution environment for the image forming apparatus. The CPU 101 loads an extended application stored in the storage 104 into the RAM 102 and then executes the extended application. Thus, an operation corresponding to each module illustrated in FIG. 2 is implemented. On the OS 201, native programs 210 for controlling the image processing units including the printer 195, a facsimile, and the scanner 270 are provided. Further, on the OS 201, virtual machines (VMs) 230 serving as an extended application execution environment are operating. Each VM 230 is a module for interpreting and executing an application for controlling an extended application operating on the VMs 230. According to the present exemplary embodiment, the VMs 230 are software modules operating on the CPU 101. A Java (registered trademark) interpreter for interpreting and executing a byte code included in an extended application is an example of a VM. An interpreter for interpreting a Lua language system for interpreting and executing a script included in an extended application is also applicable. More specifically, a VM 230 is software for interpreting and executing an abstract byte code or script having little machine dependency. The VMs 230 convert a byte code or script into native instructions which can be interpreted by the OS and CPU 101. The native instructions are directly or indirectly executed by the CPU 101. The VMs 320 are also directly or indirectly executed by the CPU 101 to implement various operations.

The native programs 210 include native threads 214 for controlling the image processing units including the printer 195, a facsimile, and the scanner 270, and VM threads 215 for operating the VMs 230. The number of the VM threads 215 corresponds to the number of the VMs 230. In this case, three different VM threads 211, 212, and 213 are generated.

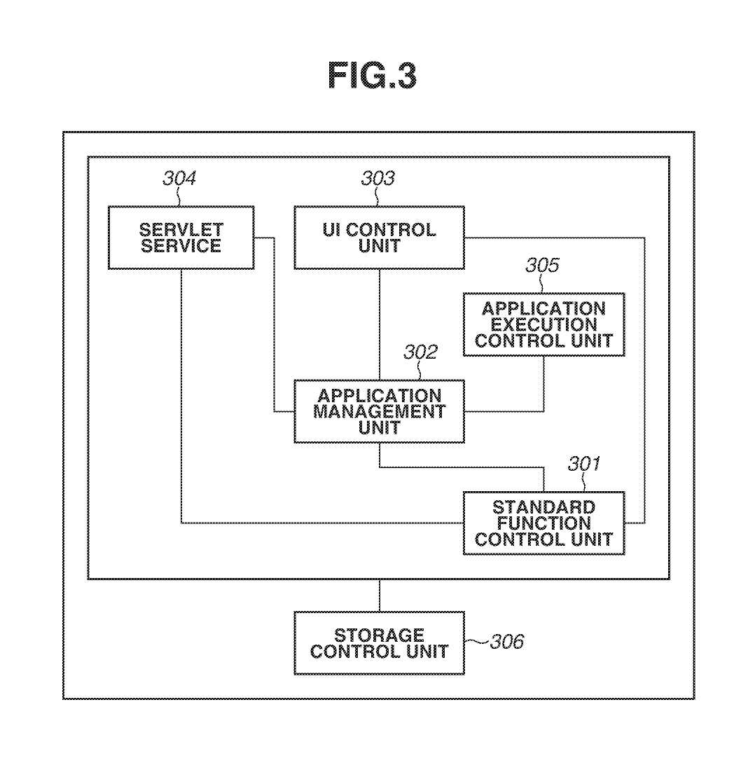

VM system services 220 are utility libraries commonly utilized by the extended applications 240. Calling the functions of the VM system services 220 from the extended applications 240 makes it possible to save time and effort for developing extended applications or access each module of the image forming apparatus. The VM system services 220 include a standard VM system service 221 operated at least as a VM and an extended VM system service 222 for accessing each module of the image forming apparatus and providing the functions of the OS. The standard VM system service 221 is a basic framework provided by what is called a Lua processing system. The extended VM system service 222 is an extensive framework group for providing application programming interfaces (APIs) for performing various control on the image forming apparatus. The VMs 230 are also provided with other framework functions (not illustrated) to be described below with reference to FIG. 3.

The VMs 230 execute the extended applications 240. A VM 230 is generated for each thread of the extended applications 240. Referring to FIG. 3, a VMA-1 231 and a VMA-2 232 for operating two different threads on an extended application A241, and VMB-1 for operating one thread on an extended application B242 are generated.

A main menu screen displayed on the operation unit 112 of the image forming apparatus displays an icon for each extended application 240. When the operation unit I/F 106 detects that the icon is selected by the user, via the operation unit 112, the operation unit I/F 106 transmits information about the selection to the CPU 101. Upon reception of the information, the CPU 101 controls processing to activate the extended application 240 selected by the user.

FIG. 3 illustrates an example of a configuration of a software module operating on the CPU 101 of the image forming apparatus according to the present exemplary embodiment. FIG. 3 illustrates functions implemented by the software modules illustrated in FIG. 2 from another viewpoint. A servlet service 304 and a user interface (UI) control unit 303 operate on the native threads 214. These modules are implemented by the C language. An application management unit 302 and an application execution control unit 305 are modules which may be included in the VM system services 220. These modules are also implemented by the C language, and at least either one of these modules operates on a native thread 214. These modules also operate in collaboration with the native programs 210. A storage control unit 306 can also be implemented by the C language, and operates as a part of the native programs 210. A servlet service 304 is a module for distributing requests when a Hypertext Transfer Protocol (HTTP) access is performed via the network I/F 110. Requests are distributed to the application management unit 302 or the standard function control unit 301 based on the Universal Resource Locator (URL) received and accessed. The UI control unit 303 is a module for displaying a screen on the operation unit 112, receiving an operation from the user, and transmitting the operation information to a suitable module (the application management unit 302 or the standard function control unit 301). The application management unit 302 is a module for managing the installation and activation of installed extended applications 240. The application execution control unit 305 is a module for performing execution control of the extended applications 240 activated by the application management unit 302. More specifically, the application execution control unit 305 controls the VM threads 215, the VM system services 220, the VMs 230, and the extended applications 240. The storage control unit 306 is a module for performing record management on setting information of the image forming apparatus. Each module accesses the storage control unit 306 to reference and set setting values. The standard function control unit 301 is a module for controlling the copy and scanning functions of the image forming apparatus, and performing other control (for example, control of the USB host I/F 113) required for the image forming apparatus. Each module illustrated in FIG. 3 operates on the native thread 214 illustrated in FIG. 2. The storage control unit 306 operates on the native threads 214 to collect information about the image forming apparatus in collaboration with the OS 201. A storage control unit 226 can also collect information from other extended applications via the OS 201. For example, other extended applications include a login application. The login application and the OS 201 grasp and store the user identifier (ID) of the user currently logging in a device. The storage control unit 306 can collect the above-described information, and manages such information as an example of information about the image forming apparatus. The storage control unit 306 may be implemented as one function of the OS 201.

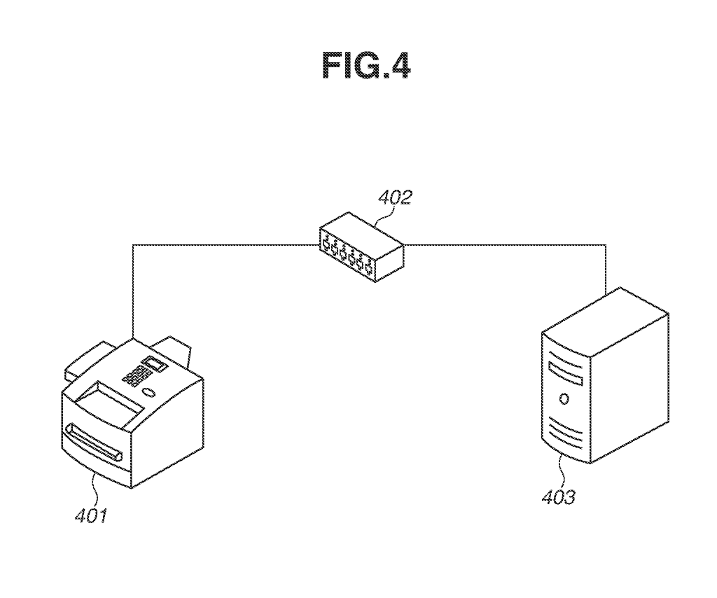

FIG. 4 illustrates an example of a device configuration of a printing system including the image forming apparatus according to the present exemplary embodiment. This printing system includes an image forming apparatus 401, a network router 402, and an external apparatus 403 such as a personal computer (PC). The external apparatus 403 such as a PC is used to install via an installer an extended application on the image forming apparatus 401 connected via a network, and change settings of an extended application on the image forming apparatus 401 connected via a browser. The network router 402 mediates communication between the image forming apparatus 401 and the external apparatus 403 such as a PC. In response to an installation request from the external apparatus 403 such as a PC, the image forming apparatus 401 performs processing for installing an extended application and returns an HTTP response to an HTTP request.

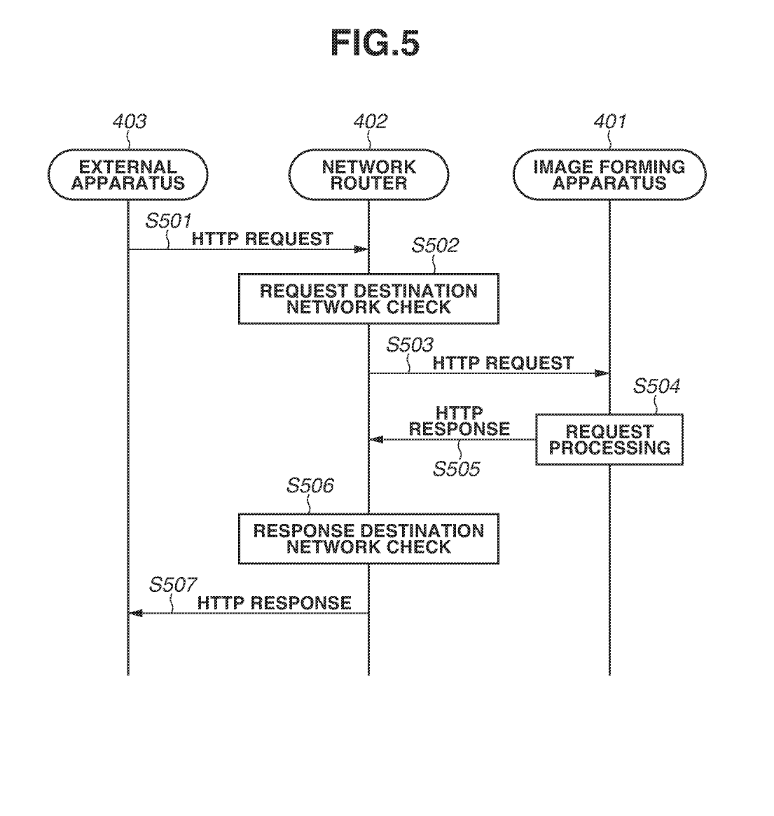

FIG. 5 is an example flowchart illustrating processing since the image forming apparatus 401 illustrated in FIG. 4 receives an HTTP request from the external apparatus 403 such as a PC until it returns an HTTP response.

First of all, the external apparatus 403 such as a PC transmits an HTTP request (S501) to the network router 402. In step S502, based on the HTTP request (S501), the network router 402 performs a request destination network check. When the network router 402 determines that a communication check successfully ends, the network router 402 transmits an HTTP request (S503) to the image forming apparatus 401. On the other hand, when the network router 402 determines that a communication check fails, the network router 402 transmits an error notification to the external apparatus 401. Upon reception of the HTTP request in step S503, then in step S504, the image forming apparatus 401 performs request processing. Then, the image forming apparatus 401 returns an HTTP response (S505) to the network router 402 as required. Upon reception of the HTTP response (S505), then in step S506, the network router 402 performs a request destination network check. When a communication check successfully ends, the network router 402 transmits an HTTP response (S507) to the image forming apparatus 401.

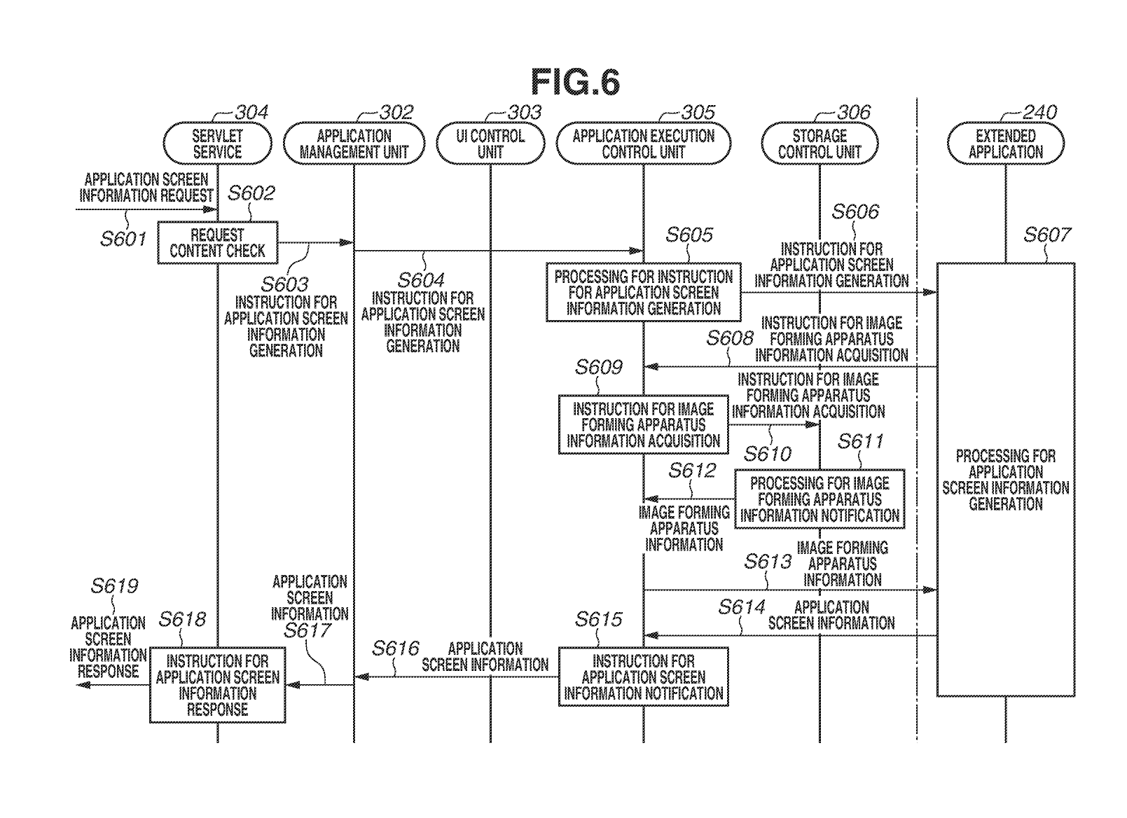

A premise technology for the present exemplary embodiment will be described below with reference to FIG. 6. FIG. 6 is a sequence diagram illustrating a processing flow since the image forming apparatus 401 receives an application screen information request (S601) that is an HTTP request until it returns an application screen information response (S619) that is an HTTP response. The processing illustrated in FIG. 6 is triggered when the modules illustrated in FIG. 3 are implemented by the CPU 101.

Referring to FIG. 6, the broken line indicates the boundary between processing by the software modules built into the image forming apparatus 401 and processing by the extended application 240, and the numbers correspond to the reference numerals of the modules illustrated in FIG. 3. The servlet service 304 receives an application screen information request (S601) that is an HTTP request from the external apparatus 403 such as a PC.

The application screen information request received via the network router 402 and the network I/F 110 is transmitted to the servlet service 304. The premise exemplary embodiment for the present disclosure assumes that the application screen information request (S601) is an HTTP request generated in a URL access performed by the external apparatus 403 such as a PC by using a browser. In step S602, the servlet service 304 determines whether the transmitted application screen information request (S601) is a request on an extended application screen or a request on a screen specific to the image forming apparatus, through a request contents check.

FIG. 6 illustrates a case where the transmitted request is determined to be a request on the extended application screen as a result of the request content check (S602). In this case, the servlet service 304 transmits an instruction for application screen information generation (S603) to the application management unit 302.

Based on the received instruction for application screen information generation (S603), the application management unit 302 transmits an instruction for application screen information generation (S604) to the application execution control unit 305.

Upon reception of the an instruction for application screen information generation (S604), the application execution control unit 305 performs the following processing. More specifically, in processing for instruction for application screen information generation (S605), the application execution control unit 305 determines an extended application 240 subjected to the instruction for screen information generation (S604) out of the extended applications 240. Subsequently, the application execution control unit 305 transmits an instruction for application screen information generation (S606) to the VM thread 215 on which the target extended application 240 is operating. The instruction for application screen information generation includes the identifier of the extended application 240 subjected to the instruction for screen information generation.

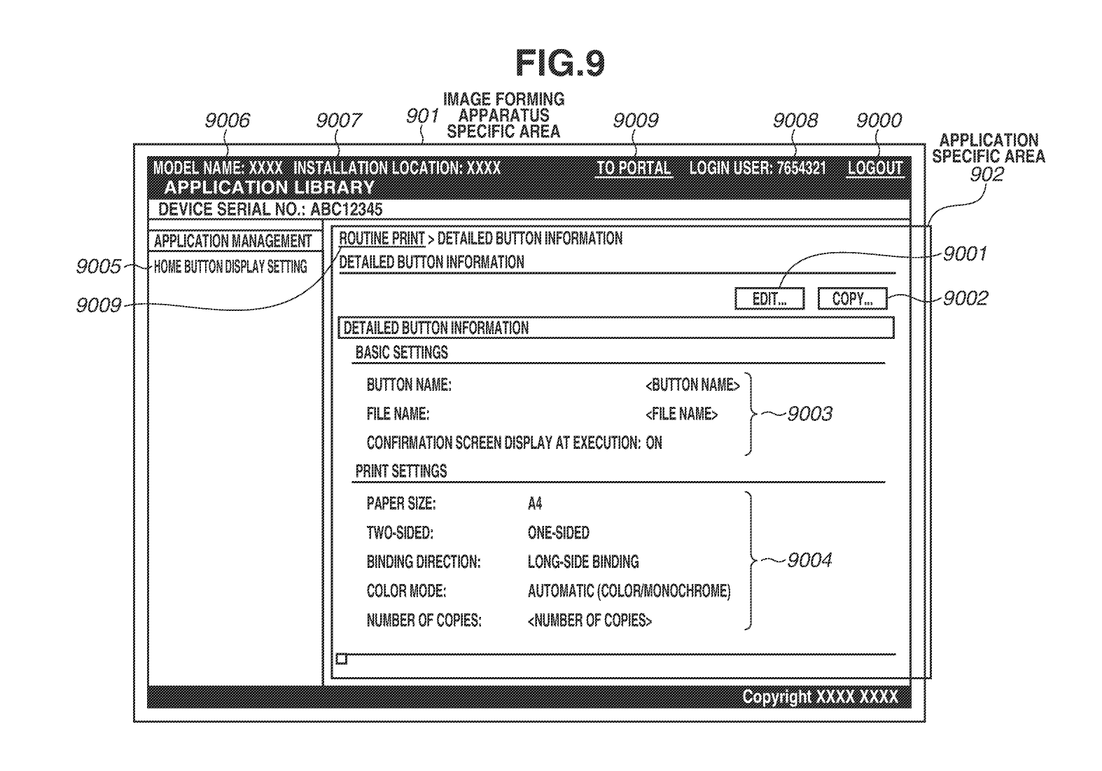

Upon reception of the instruction for application screen information generation (S606), the extended application 240 returns application screen information (S614). In the meantime, the extended application 240 performs the following processing. Upon reception of the instruction for application screen information generation (S606), the extended application 240 transmits an instruction for image forming apparatus information acquisition (S608) to the application execution control unit 305 to request the application execution control unit 305 for image forming apparatus specific information. Upon reception of the instruction for image forming apparatus information acquisition (S608), the application execution control unit 305 performs the following processing. In steps S609, the application execution control unit 305 generates an instruction for reading image forming apparatus specific information (instruction for image forming apparatus information acquisition (S610)) and transmits the instruction for image forming apparatus information acquisition (S610) to the storage control unit 306. In step S611, the storage control unit 306 reads the image forming apparatus specific information. Then, the storage control unit 306 transmits the image forming apparatus specific information (the image forming apparatus information (S612)) to the application execution control unit 305. As a response to the instruction for image forming apparatus information acquisition (S608), the application execution control unit 305 generates application screen information (S613) by using the image forming apparatus specific information. Then, the extended application 240 generates application screen information and returns the application screen information (S614) to the application execution control unit 305. According to the premise exemplary embodiment for the present disclosure, the following image forming apparatus specific information is acquired from the storage control unit 306. For example, the image forming apparatus specific information includes the image forming device name, serial number, installation location, and shortcut information to a UI screen specific to the image forming apparatus. The serial number is an example of serial information. The application screen information (S614) is assumed to be HTML format screen information. For example, the image forming apparatus specific information includes information to be displayed on an image forming apparatus specific area 901 illustrated in FIG. 9.

Upon reception of the application screen information (S614), the application execution control unit 305 performs the following processing. More specifically, in step S615, the application execution control unit 305 receives an instruction for application screen information notification. The application execution control unit 305 transmits the application screen information (S616) to the application management unit 302. Subsequently, the application management unit 302 transmits the application screen information (S617) to the servlet service 304. The serial number is an example of serial information.

Upon reception of the application screen information (S617), the servlet service 304 performs the following processing. More specifically, in step S618, the servlet service 304 generates an instruction for application screen information response (S619). Then, the servlet service 304 transmits the application screen information response (S619) that is an HTTP response to the external apparatus 403. The response is transmitted to the external apparatus 403 such as a PC via the network I/F 110 and the network router 402. The premise exemplary embodiment for the present disclosure assumes that the application screen information response (S619) is returned as a response to the HTML format screen information (S601) transmitted in the processing in steps S614 to S617.

The HTML format screen information is returned to a web browser as a response to the application screen information request that is a URL access.

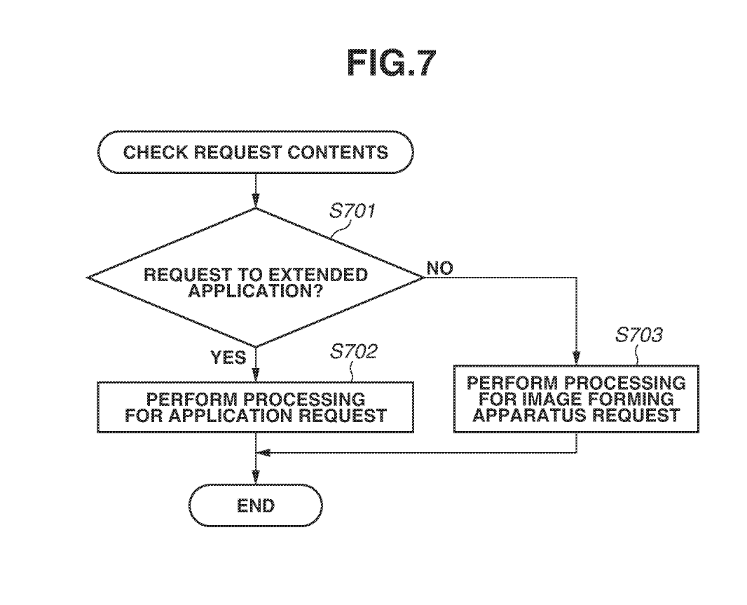

FIG. 7 is a flowchart illustrating processing in the request content check (S602) illustrated in FIG. 6.

The processing illustrated in FIG. 7 is triggered when the application management unit 302 is implemented by the CPU 101. The processing is activated upon reception of a request. In step S701, in the request content check, the CPU 101 determines whether the received request is a request to the extended application 240. When the received request is a request to the extended application 240 (YES in step S701), the processing proceeds to step S702. In step S702, the CPU 101 performs processing for application request. On the other hand, when the received request is not a request to the extended application 240 (NO in step S701), the processing proceeds to step S703. In step S703, the CPU 101 performs processing for image forming apparatus request. Referring to FIG. 6, the received request is a request to the extended application 240 and the request contents are a screen generation request. Therefore, in the processing for application request (S702), the CPU 101 transmits an instruction for application screen information generation (S603).

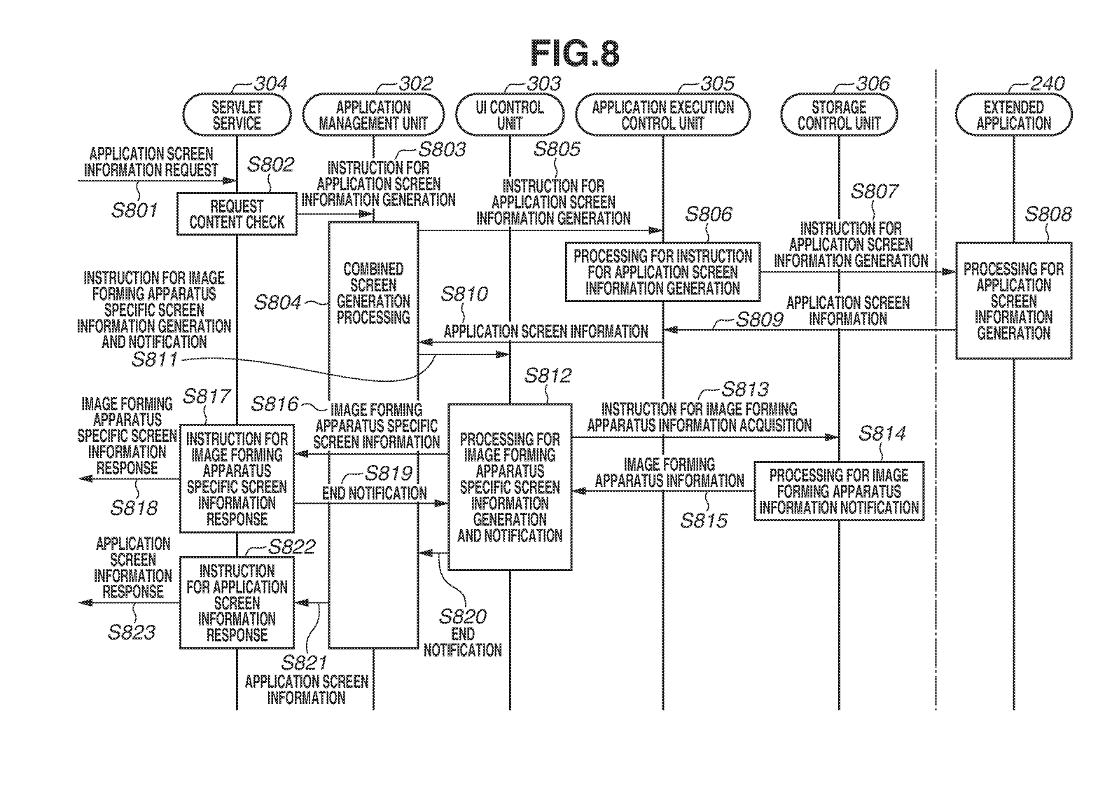

FIG. 8 is a sequence diagram illustrating a processing flow since the image forming apparatus 401 receives an application screen information request that is an HTTP request until it returns an HTTP response, according to an exemplary embodiment of the present disclosure. The processing illustrated in FIG. 8 is triggered when each module illustrated in FIG. 3 is implemented by the CPU 101.

Referring to FIG. 8, the broken line indicates the boundary between the processing by the module group for controlling the system in the image forming apparatus 401 and the processing by the extended application 240. The processing illustrated in FIG. 8 since the servlet service 304 receives an application screen information request (S801) until it transmits an instruction for application screen information generation (S803) to the application management unit 302 is similar to the processing by the premise exemplary embodiment for the present disclosure illustrated in FIG. 6. The application screen information request (S801) is similar to the application screen information request (S601) according to the premise exemplary embodiment for the present disclosure. The present exemplary embodiment assumes that the application screen information request is an HTTP request generated in a URL access performed by the external apparatus 403 such as a PC by using a browser.

Upon reception of an instruction for application screen information generation (S803), then in step S804, the application management unit 302 generates screen information depending on the extended application 240 and screen information (in the image forming apparatus specific area 901) depending on the image forming apparatus. In step S804, the application management unit 302 transmits the screen information as an HTTP response. This processing for combining the screen information is referred to as combined screen generation processing. FIG. 8 illustrates processing when the screen information depending on the image forming apparatus and the screen information depending on the extended application 240 are combined in this order. The application management unit 302 transmits an instruction for application screen information generation (S805) to the application execution control unit 305. In step S806, the application execution control unit 305 performs processing for instruction for application screen information generation. The application execution control unit 305 transmits an instruction for application screen information generation (S807) to the extended application 240. In step S808, the extended application 240 generates application screen information. The extended application 240 transmits the application screen information (S809) to the application execution control unit 305. The application execution control unit 305 transmits the application screen information (S810) to an application management unit 302 as it is. According to the exemplary embodiment of the present disclosure, information acquired by the instruction for application screen information generation (S805) is the application screen information (S810) and image forming apparatus specific screen information. These pieces of information are assumed to be HTML format screen information. The image forming apparatus specific screen information (S816) acquired by an instruction for image forming apparatus specific screen information generation and notification (S811) is also assumed to be HTML format screen information.

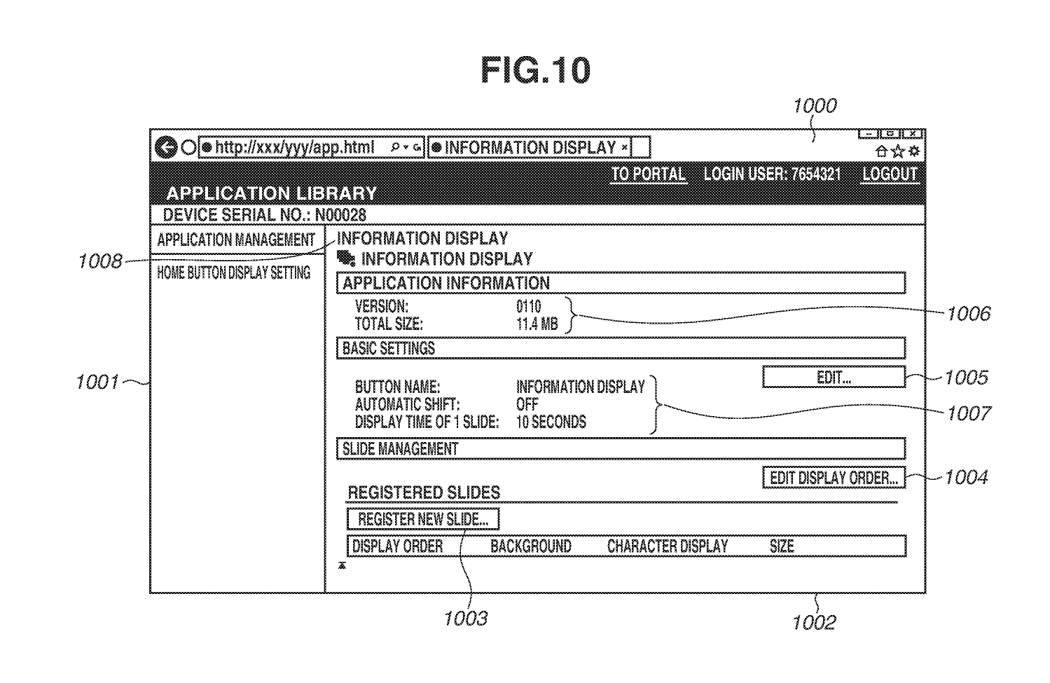

The application management unit 302 transmits an instruction for image forming apparatus specific screen information generation and notification (S811) to the UI control unit 303. In step S812, the UI control units 303 transmits an instruction for image forming apparatus information acquisition (S813) to the storage control unit 306. In step S814, the storage control unit 306 collects information about the image forming apparatus. For example, the storage control unit 306 collects information displayed in the image forming apparatus specific area 901 illustrated in FIG. 9 and an image forming apparatus specific area 1001 illustrated in FIG. 10 via the OS 201.

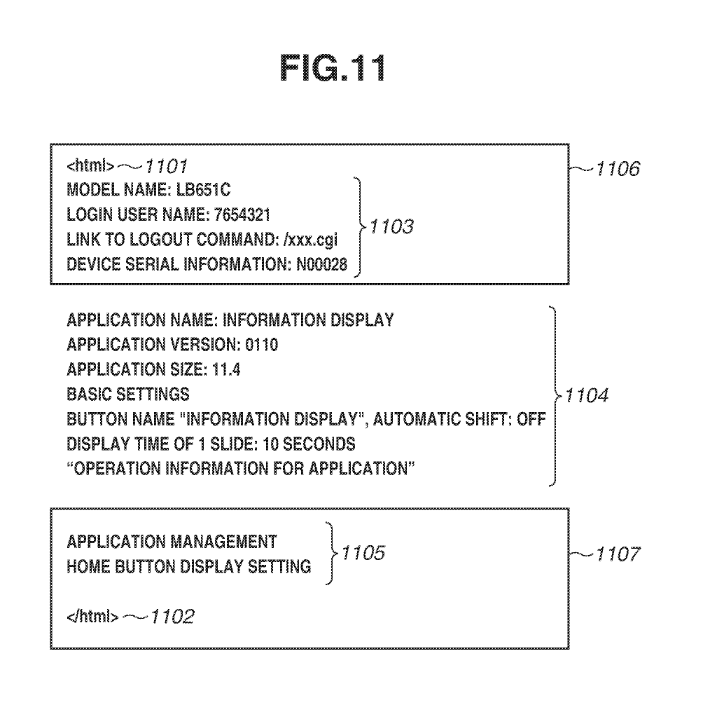

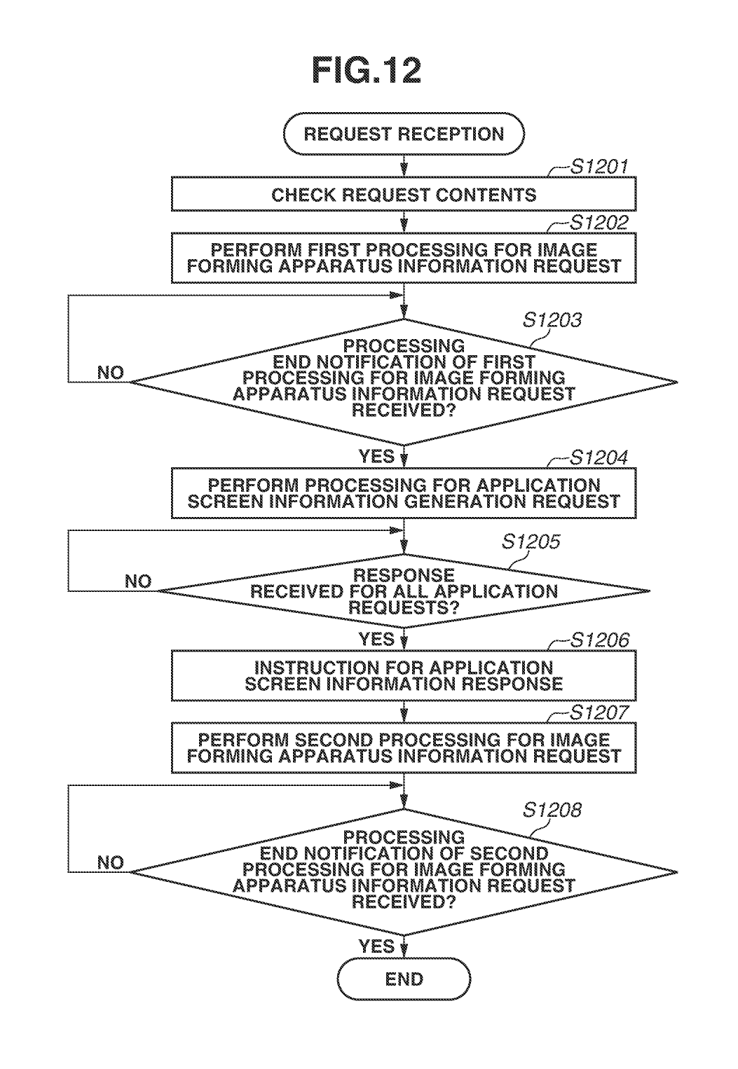

Therefore, according to the exemplary embodiment of the present disclosure, the storage control unit 306 transmits the collected information (image forming apparatus information (S815)) to the UI control unit 303. In step S812, based on the transmitted image forming apparatus information (S815), the UI control unit 303 generates image forming apparatus specific screen information. The image forming apparatus specific screen information (described below with reference to FIGS. 11 and 12) is, for example, information 1104 described in the HTML format, as illustrated in FIG. 11. Subsequently, the UI control unit 303 transmits the image forming apparatus specific screen information (S816) to the servlet service 304. In step S817, the servlet service 304 generates an image forming apparatus specific screen information response. The servlet service 304 transmits the image forming apparatus specific screen information response (S818).

In the combined screen generation processing, the servlet service 304 transmits HTML format screen information. In step S817, before the screen information transmission, the servlet service 304 supplies information indicating the start of HTML to the head of the information to be transmitted first. In step S822, the servlet service 304 supplies information indicating the end of HTML to the end of information to be last transmitted. In steps 5817 and S822, the servlet service 304 transmits information to the browser mounted on the external apparatus 403 in one session. The browser handles HTML data received a plurality of times as one piece of HTML data. The browser of the external apparatus 403 is assumed to constitute and display the screen as illustrated in FIG. 9.

Of the combined screen generation processing (S804) illustrated in FIG. 8, the processing in steps S805 to S810 indicates processing for generating screen information depending on the extended application 240 and the processing in steps S811 to S820 indicates processing for generating screen information depending on the image forming apparatus. The processing for generating screen information depending on the extended application 240 (S805 to S810) will be described below. More specifically, in this processing, screen information depending on the extended application 240 is once stored, and an HTTP response is transmitted in order of combining screen information. Subsequently, in the processing for generating screen information depending on the image forming apparatus (S811 to S820), an HTTP response is transmitted without storing screen information. When storing the generated screen information and then transmitting an HTTP response, the order of combining screen information can be changed after the screen information generation. When an HTTP response is transmitted without storing the generated information, memory resources can be saved. The present exemplary embodiment makes it possible to change whether to temporarily store the screen information according to the use.

The above-described processing can be summarized as follows. The processing for generating screen information depending on the extended application 240 (S805 to S810) will be described below. The application management unit 302 transmits an instruction for application screen information generation (S805) to the application execution control unit 305. Upon reception of the instruction for application screen information generation (S805), the application execution control unit 305 performs the following processing in the processing for instruction for application screen information generation (S806). The application execution control unit 305 performs similar processing to the processing for instruction for application screen information generation (S605) illustrated in FIG. 6. The application execution control unit 305 transmits an instruction for application screen information generation (S807) to the extended application 240. Upon reception of the instruction for application screen information generation (S807), then in step S808, the extended application 240 generates application screen information in the processing for application screen information generation. The extended application 240 transmits the application screen information (S810) to the application management unit 302 via the application execution control unit 305.

In the processing for screen information generation and notification depending on the image forming apparatus (S811 to S820), the following processing is performed. The application management unit 302 transmits an instruction for image forming apparatus specific screen information generation and notification (S811) to the UI control unit 303. Upon reception of the instruction for image forming apparatus specific screen information generation and notification (S811), then in step S812, the UI control unit 303 performs processing for image forming apparatus specific screen information generation and notification to generate and transmit image forming apparatus specific screen information. In the processing for image forming apparatus specific screen information generation and notification (S812), the UI control unit 303 acquires the image forming apparatus information from the storage control unit 306 in the processing in steps S813 to S815. Upon acquisition of the image forming apparatus information (S815), the UI control unit 303 generates image forming apparatus specific screen information and transmits the image forming apparatus specific screen information (S816) to the servlet service 304. Upon reception of the image forming apparatus specific screen information (S816), then in step S817, the servlet service 304 generates an instruction for image forming apparatus specific screen information response. Subsequently, the servlet service 304 transmits an image forming apparatus specific screen information response (S818) to the external apparatus 403 such as a PC.

The image forming apparatus specific screen information response is transmitted as an HTTP response via the network I/F 110 and the network router 402.

The servlet service 304 returns an end notification (S819) to the UI control unit 303. The UI control unit 303 transmits an end notification (S820) to the application management unit 302. The image forming apparatus specific screen information response (S818) is assumed as an HTTP response to the application screen information request (S801) that is a URL access. This response returns HTML format screen information including information indicating the start of HTML in the head. The information exchange (S816 and 5819) is performed regardless of the combined screen generation processing (S804) to restrict the amount of memory consumption by the application management unit 302. However, the image forming apparatus specific screen information generated in step S812 may be once received by the application management unit 302. In this case, the combined screen generation processing based on the image forming apparatus specific screen information and the screen information from the extended application 240 may be performed by the application management unit 302, and the resultant information may be transmitted to the servlet service 304.

Upon reception of the end notification (S820), the application management unit 302 transmits to the servlet service 304 the application screen information (S821) that is stored screen information depending on the extended application 240. Upon reception of the application screen information (S821), then in step S822, the servlet service 304 transmits an instruction for application screen information response. Subsequently, the servlet service 304 transmits the application screen information response (S823) that is an HTTP response to the external apparatus 403 such as a PC via the network I/F 110 and the network router 402. In this case, the application screen information response (S823) includes information indicating the end of HTML at the end. The servlet service 304 returns HTML format screen information as an HTTP response to the application screen information request (S801) that is a URL access.

FIG. 9 illustrates an example of screen information generated when the servlet service 304 receives an application screen information request (S801) according to the exemplary embodiment of the present disclosure. The image forming apparatus specific area 901 displays the device name, installation location, UI specific to the image forming apparatus, extended application management menu, and other UIs and information related to control of the image forming apparatus. An application specific area 902 displays a UI related to application settings. As described above with reference to FIG. 8, the servlet service 304 transmits as an HTTP response to the browser the screen information depending on an extended application and the screen information depending on the image forming apparatus a plurality of times. Then, the browser combines the screen information. This makes it possible to combine the image forming apparatus specific area 901 with the application specific area 902 to generate a combined screen as illustrated in FIG. 9. Thus, when changing the display of only the image forming apparatus specific area 901 with changes of the image forming apparatus, the screen contents can be changed without modifying the extended application. For example, even if the contents of the information to be displayed in the image forming apparatus specific area 901 has been changed, the specifications of the extended application for generating information to be displayed in the application specific area 902 is not changed. A field 9006 displays the model name and a field 9007 displays the installation location. A field 9008 displays the name of a user authenticated through a password and user name by the image forming apparatus. A portal screen specification portion 9009 is a link to a predetermined URL corresponding to the image forming apparatus or an external server.

These pieces of information displayed in the image forming apparatus specific area 901 are examples of information about the image forming apparatus. As described above with reference to FIG. 8, these pieces of information are acquired via the storage control unit 306. The application specific area 902 displays a button 9001 for transmitting an instruction to an application, and also displays basic settings 9003 and print settings 9004 for the application. The basic settings 9003 and the print settings 9004 can be edited by using the Edit button 9001. When the user presses a Copy 9002, a similar instance can be copied in the image forming apparatus as settings of the extended application. As an example of information about the application, these settings are acquired from the extended application and displayed in the application specific area 902. The portal screen specification portion 9009 displays “Routine Print”. The screen of the application specific area 902 is an operation screen for a routine print application that is an example of the extended application. With routine print, predetermined setting values are maintained in the extended application like a button, and can be registered to the image forming apparatus like a button. Then, the user presses the “Routine Print” button from the operation panel of the image forming apparatus to call the extended application. The “Routine Print” refers to an extended application like a macro for printing a specified file based on the print settings 9004. FIG. 9 illustrates a home button call setting 9005. The operation to be performed when the home button on the image forming apparatus is pressed can be specified on a printing apparatus from the browser.

FIG. 10 illustrates a display example 1000 related to other extended applications.

FIG. 10 illustrates an application specific area 1002 which displays information about an extended application. This information includes an extended application name 1008, and a version and an application size 1006 as (extended) application information. Basic settings 1007 include a button name that is the name of the extended application to be displayed on the operation unit 112. An information display application that is an example extended application is a bulletin board application like what is called a screen saver. When a predetermined period has elapsed, the information display application displays a slide show on a full-screen basis on the operation unit 112 of the image forming apparatus 401. This slide show can be transmitted from the web browser to the image forming apparatus 401 for registration via a registration unit 1003. The basic settings 1007 include an “Automatic Shift” setting for specifying whether to automatically perform a slide show. The display time of the slide show can also be displayed. These basic settings 1007 can be edited and changed by using a Edit button 1005. Edited setting values are transmitted from the web browser to the image forming apparatus and then set to the extended application.

FIG. 10 illustrates the image forming apparatus specific area 1001 which displays almost similar information to that in the application specific area 902 illustrated in FIG. 9. As described above, these pieces of information are displayed based on the information about the image forming apparatus acquired from the storage control unit 306 of the image forming apparatus.

FIG. 11 schematically illustrates information for instructing the web browser to display the screen illustrated in FIG. 10. This information is eventually received and interpreted by the web browser for display use. The information starts with an HTML start command 1101. The information includes an example of image forming apparatus information 1103, an example of application information 1104, and an example of image forming apparatus information 1105. The information ends with an HTML end command 1102.

According to the present exemplary embodiment, firstly, a web browser refers to the web browser installed in the external apparatus 403. The web browser receives the information illustrated in FIG. 11 from the image forming apparatus 401. Then, the web browser displays the screens illustrated in FIGS. 9 and 10 on the display of the external apparatus 403. Secondly, the web browser may be built in the image forming apparatus 401. More specifically, an instruction for built-in web browser activation is executed from the operation unit 112. Operating the operation unit 112 to make the built-in web browser access a predetermined URL of the image forming apparatus 403 corresponds to the issuance of an application screen information request. Then, the servlet service 304 may start the processing for the application screen information request (S801) illustrated in FIG. 8. In this case, the screens illustrated in FIGS. 9 and 10 may be displayed on the operation unit 112 by the built-in web browser.

A modification illustrated in FIG. 8 will be described below. The servlet service 304 receives one application screen information request (S801). In response to this request, in step S804, the application management unit 302 may issue an instruction for application screen information generation a plurality of times. In this case, a HTTP response may be transmitted from the application management unit 302 to the application execution control unit 305 a plurality of times. In this case, the processing in steps S804 to S810 and S821 may be performed a plurality of times.

In response to the reception of the application screen information, the application management unit 302 transmits an instruction for image forming apparatus specific screen information generation and notification to the UI control unit 303.

In response to this processing, as described above, the processing in steps S813 to S819 is performed. Upon reception of an end notification (S819) from the servlet service 304, the UI control unit 303 transmits the end notification (S820) to the application management unit 302. As described above, the application management unit 302 transmits an instruction for application screen information generation (S805) to the application execution control unit 305. The application management unit 302 transmits an instruction for image forming apparatus specific screen information generation and notification (S811) to the UI control unit 303. The order of these pieces of processing can be defined as a code managed by the application management unit 302. Basically, the application management unit 302 sequentially performs these pieces of processing since it can recognize the end of each piece of processing (S810 and S820). For example, suppose that steps S811, S805, and S811 are defined in the above-described code in this order. Then, the application management unit 302 can be controlled to issue requests in this order. In this case, the application management unit 302 controls the application execution control unit 305 and the extended application 240 to add <HTML/> to the first instruction for image forming apparatus specific screen information generation and notification (S811). The application management unit 302 controls the UI control unit 303 to add </HTML> to the last instruction for image forming apparatus specific screen information generation and notification (S811). These pieces of processing can also be described in the code. FIG. 12 is a flowchart illustrating processing similar to the flowchart illustrated in FIG. 7, and description will be made centering on differences.

FIG. 12 illustrates an example of processing by the application management unit 302 according to the present exemplary embodiment. This processing is triggered when the application management unit 302 is implemented by the CPU 101.

This processing is performed in the image forming apparatus 401. This processing is a modified version of the processing of the application management unit 302 in the sequence diagram illustrated in FIG. 8. This processing is started when an application screen information request is received from the web browser. In step S1201, the application management unit 302 analyzes the contents of the received application screen information request. The application screen information request includes an application screen information generation request and an image forming apparatus information request. The image forming apparatus information request can also be divided into a plurality of requests before processing. According to the present exemplary embodiment, the image forming apparatus information request is divided into two before processing. In step S1202, the CPU 101 performs the first processing for the image forming apparatus information request out of processing for the two division requests. More specifically, the application management unit 302 transmits an instruction for image forming apparatus specific screen information generation and notification (similar to S811) to the UI control unit 303. In this case, the CPU 101 requests to return a response with <HTML/> supplied to the first line. Subsequently, the CPU 101 performs similar processing to steps S812 to S815 and S816. Based on the information acquired from the storage control unit 306, the UI control unit 303 generate the image forming apparatus specific screen information 1103. Then, the UI control unit 303 transmits the image forming apparatus specific screen information 1103 to the servlet service 304. The image forming apparatus specific screen information 1103 is equivalent to information 1106 illustrated in FIG. 11. Then, the UI control unit 303 transmits the image forming apparatus specific screen information to the servlet service 304 and also transmits a processing end notification to the application management unit 302. In step S1203, the application management unit 302 determines whether the end notification is received. Upon reception of the end notification, the application management unit 302 determines that the first processing for image forming apparatus information request is completed. When the application management unit 302 determines that the end notification is received (YES in step S1203), the processing proceeds to step S1204. In step S1204, the application management unit 302 performs processing for the application screen information generation request. More specifically, the application management unit 302 transmits an instruction for application screen information generation (similar to S805) to the application execution control unit 305. Then, the CPU 101 subsequently performs the processing in steps S806 to step S810. The application screen information generation request may be divided into a plurality of requests before processing. When the application management unit 302 determines that a response is received for all application screen information generation requests (YES in step S1205), the processing proceeds to step S1206. In step S1206, the application management unit 302 transmits application screen information (similar to S821) to the servlet service 304. Subsequently, the CPU 101 performs similar processing to steps S822 and S823. The application screen information is equivalent to the information 1104 illustrated in FIG. 11.

Following step S1206, the processing proceeds to step S1207. In step S1207, the application management unit 302 performs the second processing for image forming apparatus information request. More specifically, the application management unit 302 processes the remaining image forming apparatus request confirmed in step S1201. More specifically, the application management unit 302 transmits an instruction for image forming apparatus specific screen information generation and notification (similar to S811) to the UI control unit 303. In this notification, the application management unit 302 requests the UI control unit 303 to supply </HTML> at the end of the image forming apparatus specific screen information. Subsequently, the CPU 101 performs similar processing to steps S811 to S816. Upon completion of the processing for image forming apparatus screen information generation and the processing for transmitting the information to the servlet service 304, the UI control unit 303 transmits an end notification to the application management unit 302. The image forming apparatus specific screen information is equivalent to information 1107 illustrated in FIG. 11. In step S1208, the application management unit 302 receives this end notification as an end notification of the second processing for image forming apparatus information request. Upon reception of the end notification in step S1208, the application management unit 302 ends the processing, and waits for another request.

Upon reception of the image forming apparatus specific screen information and the application screen information, the servlet service 304 performs the following processing. The servlet service 304 wraps the received information as it is in an HTTP response and transmits the HTTP response to the web browser. This processing is similar to steps S818 and S823.

This means that the web browser built in the image forming apparatus 401 or the web browser installed in the external apparatus 403 receives the information illustrated in FIG. 11 when the result of the determination in step S1208 is YES. Then, the web browser recognizes responses to the requests issued in steps S1203, S1205, and S1208 as one piece of HTML data. Then, the web browser displays the screen illustrated in FIG. 10 on the operation unit 112 of the image forming apparatus 401 or the display of the external apparatus 403.

The image forming apparatus 401 capable of mounting system software and extended applications for extending the functions of the image forming apparatus 401 has been disclosed. Examples of image forming apparatuses include printers and multifunction peripherals. The application management unit 302 and the application execution control unit 305 acquire the information about the image forming apparatus obtained by the storage control unit 306 of the image forming apparatus 401 implemented by the CPU 101. The application management unit 302 and the application execution control unit 305 also acquire the information about the extended application 240 obtained from the extended application 240.

Based on the information acquired by each module, the servlet service 304 separately outputs information to be displayed on the web browser. The web browser is an example of a display application different from the extended application 240.

The servlet service 304 further accepts an HTTP request. Then, the image forming apparatus includes a control unit for controlling standard functions. The servlet service 304 determines whether the received HTTP request is a request related to the expanded functions of the extended application 240 or a request related to the standard functions thereof.

Based on the result of the determination by the servlet service 304, the servlet service 304 distributes each HTTP request to allow the expanded functions or standard functions to be accessed.

The servlet service 304 may transmit to the web browser the information to be displayed on the web browser as a plurality of HTTP responses.

The servlet service 304 outputs the following information as information to be displayed on the web browser. More specifically, the servlet service 304 outputs an HTTP response including at least one of the information about the image forming apparatus 401 and the information about the extended application 240, and an HTML start header.

The servlet service 304 also outputs an HTTP response including at least one of the information about the image forming apparatus 401 and the information about the extended application 240, and an HTML end header. These outputs may or may not be separated.

The information about the image forming apparatus 401 includes the serial number corresponding to the image forming apparatus 401, model information, and operation information related to the image forming apparatus 401. The information may include one of the model name and installation location. The information about the extended application 240 includes the extended application name and information about the operation related to the extended application 240.

The image forming apparatus 401 may display the information about the image forming apparatus 401 in one frame in the above-described web browser. The information about the extended application 240 may be displayed in a frame different from the above-described frame in the same screen or in a screen changed through scrolling.

The image forming apparatus 401 may transmit information output by the servlet service 304 to the external apparatus 403 via the network I/F 110. According to the present exemplary embodiment, examples of system software include portions other than the extended applications 240 illustrated in FIG. 2. The system software generally includes platform portions (the VM system services 220 and VMs 230) of the image forming apparatus or firmware portions (the OS 201 and the native programs 210) of the image forming apparatus. In particular, examples of programs depending on the image forming apparatus include the native programs 210 and the OS 201.

According to an aspect of the present exemplary embodiment, it is possible to efficiently develop a function of displaying both the information about the image forming apparatus and the information about the extended application 240.

According to another aspect of the present exemplary embodiment, it is possible to save time and effort for correcting the extended application 240 even in a case where the information about the image forming apparatus to be displayed on the screen changes. This enables improving the compatibility between image forming apparatuses having different extended applications.

There is a function of displaying a user interface (UI) of the image forming apparatus by using a display application such as a web browser. There is a method for generating one UI screen by using an extended application in the image forming apparatus. According to the present exemplary embodiment, unlike this method, when displaying the information about the image forming apparatus on a UI screen, it is not necessary for an extended application to acquire information from the image forming apparatus and generate one UI screen including the information about the image forming apparatus at the time of UI screen generation. It is also possible to reduce the number of processes including the process of correcting the extended application each time the configuration, any setting, or other acquirable information about the image forming apparatus to be displayed on a UI screen is changed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-247183, filed Dec. 20, 2016, which is hereby incorporated by reference herein in its entirety.

What is claimed is:

1. An image forming apparatus capable of mounting system software for controlling the image forming apparatus and an extended application operating on the system software, the image forming apparatus comprising an output unit configured to output, based on an access to a uniform resource identifier (URI) corresponding to the image forming apparatus, first display information based on information acquirable from the system software of the image forming apparatus and second display information acquirable from the extended application, different from the first display information, to display the first and the second display information in a web browser.

2. The image forming apparatus according to claim 1, wherein the first and the second display information output by the output unit are displayed in different frames in one screen of the web browser.

3. The image forming apparatus according to claim 1, wherein, based on an access to one URI corresponding to the image forming apparatus, the first and the second display information are output as a plurality of different HTTP responses.

4. The image forming apparatus according to claim 3, wherein, the output unit outputs information to be displayed on the web browser as two different HTTP responses:
an HTTP response including at least one of the information about the image forming apparatus and the information about the extended application, and an HTML start header, and
an HTTP response including at least one of the information about the image forming apparatus and the information about the extended application, and an HTML end header.

5. The image forming apparatus according to claim 1, comprising:
a control unit configured to control a servlet service for receiving an HTTP request and a standard function of the image forming apparatus;
a determination unit configured to determine whether the received HTTP request is a request related to an expanded function of the extended application or a request related to a standard function of the image forming apparatus; and
a distribution unit configured to distribute the HTTP request so that either the expanded or the standard function can be accessed based on a result of the determination by the determination unit.

6. The image forming apparatus according to claim 1,
wherein the output unit transmits information to be displayed on the web browser as a plurality of HTTP responses, and
wherein each of the plurality of HTTP responses includes information output based on information about the image forming apparatus or information about the extended application.

7. The image forming apparatus according to claim 1,
wherein the information about the image forming apparatus includes at least one of serial information corresponding to the image forming apparatus, model information, operation information related to the image forming apparatus, a model name, and an installation location, and
wherein the information about the extended application includes an extended application name and information about an operation related to the extended application.

8. The image forming apparatus according to claim 1, wherein the output unit outputs information for displaying the information about the image forming apparatus in one frame of a screen of the web browser, and displaying the information about the extended application in a frame different from the frame.

9. The image forming apparatus according to claim 1, further comprising a transmission unit configured to transmit the information output by the output unit to an external apparatus via a network.

10. A method for controlling an image forming apparatus capable of mounting system software for controlling the image forming apparatus and an extended application operating on the system software, wherein a hardware processor included in the image system apparatus executes operations to cause the following processing:
receiving an access to a URI corresponding to the image forming apparatus; and
outputting, based on a received access, first display information based on information acquirable from the system software of the image forming apparatus and second display information acquirable from the extended application, different from the first display information, to display the first and the second display information in a web browser.
